(19) United States
(12) Patent Application Publication
(10) Pub. No.: US 2012/0119075 A1
(43) Pub. Date: May 17, 2012

(54) OPTICAL SENSOR FOR IDENTIFYING AND/OR AUTHENTICATING OBJECTS

(75) Inventors: Markus Gerigk, Koln (DE); Andreas Bäcker, Wuppertal (DE); Thomas Birsztejn, Dormagen (DE); Ralf Imhäuser, Langenfeld (DE); Christian Roth, Leverkusen (DE); Walter Speth, Dueren (DE); Simon Hoff, Koln (DE)

(73) Assignee: Bayer Technology Services GmbH, Leverkusen (DE)

(21) Appl. No.: 13/264,679

(22) PCT Filed: Apr. 7, 2010
(86) PCT No.: PCT/EP2010/002168

§ 371 Date: Dec. 30, 2011

(30) Foreign Application Priority Data
Apr. 16, 2009 (DE) 10 2009 017 668.3

(51) Int. Cl. H01J 40/14

(52) U.S. Cl. 250/239

(57) ABSTRACT

The invention relates to an optical sensor for identifying and/or authenticating objects on the basis of characteristic reflection patterns, and to a device comprising a plurality of sensors connected to one another.

The invention relates to an optical sensor for identifying and/or authenticating objects on the basis of characteristic reflection patterns, and to a device comprising a plurality of sensors connected to one another.

Methods for identifying and/or authenticating objects on the basis of optical features are known. WO2005088533(A1) describes for example a method by which objects can be identified and/or authenticated on the basis of their characteristic surface structure. In the method, a laser beam is focused onto the surface of the object, moved over the surface, and the beams that are scattered to different extents at different locations at the surface at different angles are detected by means of photodetectors. The scattered radiation detected represents a characteristic reflection pattern, which is unique for a multiplicity of different materials and can be copied only with very great difficulty since it can be attributed to randomnesses during the production and/or processing of the object. By way of example, paper-like objects have a production-dictated fibre structure that is unique for each object produced. The characteristic reflection patterns concerning the individual objects are stored in a database in order to be able to authenticate the object at a later point in time.

For this purpose, the object is measured again and the characteristic reflection patterns are compared with the stored reference data.

The device for authenticating objects that is disclosed in WO2005088533(A1) preferably comprises four or more photodetectors arranged in a plane around a laser. The technical teaching of WO2005088533(A1) is directed toward the fact that a larger number of photodetectors are required for achieving a higher security level. In this case, the photodetectors are arranged around the laser in a fan-shaped manner over a large angular range. Alternative components are not disclosed.

The device for authenticating objects that is disclosed in WO2005088533(A1) has the disadvantage that it has defined numbers of lasers and photodetectors, which cannot readily be varied. Should it be necessary, on account of varying requirements, to increase or decrease the numbers of lasers and photodetectors, WO2005088533(A1) gives no indication as to how this could be realized without constructing a new device.

It is generally known that optical components have to be arranged in a defined manner with respect to one another when recording signals, in order to obtain an adequate signal-to-noise ratio. In this case, the requirements made of mounting/alignment increase with the number of optical components, which has a direct influence on the production costs of corresponding sensors. No holding devices for receiving and aligning the laser and/or the photodetectors are disclosed in WO2005088533(A1). The latter does not disclose how lasers and photodetectors can be arranged simply but nevertheless precisely with respect to one another.

In the identification and/or authentication of objects it is essential that an object can always be authenticated with high accuracy at different locations and at different times. Since in most cases different devices for identification and/or authentication are used at different locations, a basic prerequisite which the devices have to satisfy is that they yield reproducible results that can be transferred from one device to another device. WO2005088533(A1) discloses no indications as to how a reproducible device for authentication which is suitable for series production could be implemented.

Since the same surface region always has to be detected during each identification and/or authentication of an object, a further requirement made of a device is that the positioning of an object with respect to laser beam and photodetectors is intended to be effected rapidly and simply in conjunction with sufficient accuracy.

Proceeding from the prior art, the formulated object is that of providing a device for identifying and/or authenticating objects on the basis of characteristic reflection patterns which yields a high signal-to-noise ratio, is simple and cost-effective to produce, is intuitive and simple to handle, flexibly usable and extendable, yields reproducible and transferable results and is suitable for series production.

According to the invention, this object is achieved by means of a sensor for recording reflection patterns in accordance with claim 1. The sensor according to the invention comprises the following components:
a block for receiving the optical components,
a laser,
optical elements for beam shaping and focusing,
at least one photodetector,
connecting means.

Optical components are understood to mean all components of the sensor which are arranged in the beam path between the laser and at least one photodetector, including the laser and the photodetector themselves. Optical elements form a selection of the optical components; they serve for beam shaping and focusing. In particular, lenses, diaphragms, diffractive optical elements and the like are referred to as optical elements.

The central element of the sensor is formed by a block, which is preferably embodied in one or two pieces and which serves for receiving all the optical components of the sensor according to the invention. The optical block comprises an identified outer surface, which is directed at the object during authentication of said object. The block comprises at least two bushings, which run towards one another in the direction of the identified outer surface—referred to simply as outer surface hereinafter. A first bushing serves to receive the laser. This bushing runs perpendicularly to the outer surface.

At least one further bushing runs at an angle α with respect to the first bushing. Said further bushing serves to receive a photodetector, wherein the photodetector in the bushing is directed towards the outer surface. The angle α between the bushing for the photodetector and the bushing for the laser lies in the range of 5° to 95°, preferably in the range of 20° to 80°, particularly preferably in the range of 30° to 70°, especially preferably in the range of 40° to 60°.

In one preferred embodiment, the block of the sensor according to the invention has three bushings: one for receiving a laser and two for receiving photodetectors. The bushings for the photodetectors preferably lie in one plane together with the bushing for the laser. They run at an angle α₁ and α₂, respectively, with respect to the first bushing for the laser. The angles α₁ and α₂ can be identical or different. They are preferably identical.

The use of a block having two or three bushings for receiving a laser and one or two photodetectors affords the advantage that the optical components can be arranged in a simple manner but nevertheless in a defined manner with respect to one another. Preferably, a stop is situated in the bushing for the laser. The laser of the sensor is pushed into the bushing against said stop, such that it assumes a predefined fixed position relative to the block and the photodetectors. If the laser has optical elements for beam shaping and focusing that are already connected to it, which is generally customary for example in the case of the laser beam sources that are commercially available nowadays, then as a result of the fixing of the laser, at the same time the focal point of the laser is unambiguously fixed. The further bushings for receiving photodetectors can likewise be provided with a stop, wherein the position of the photodetectors has to be less accurate than the position of the laser.

The block can be produced in one or two pieces from plastic in a simple manner e.g. by means of injection-moulding methods. Components can be produced with high accuracy in large numbers and in a short time by means of injection-moulding methods. This enables cost-effective series production of sufficiently precise components. The bushings can already be provided in the injection mould or subsequently be introduced into the block by means of e.g. drilled holes. Preferably, all the constituent parts of the block are already produced in one step in the injection—moulding method. It is likewise conceivable to mill the block for example from aluminium or plastic and to realize the bushings by means of drilled holes for example. Further methods for producing a block with defined bushings which are known to the person skilled in the art are conceivable.

The sensor according to the invention is furthermore characterized in that the central axes of the bushings intersect at a point lying outside the block. It has surprisingly been found that it is advantageous for the authentication if the intersection point of the central axes is simultaneously the focal point of the laser and lies at a distance of 2 to 10 mm from the outer surface.

In order to authenticate an object, the sensor according to the invention is correspondingly led at a distance over said object, such that the focal point and the intersection point of the central axes lies on the surface of the object.

In the case of the abovementioned distance range of 2 to 10 mm, the positioning of that surface of an object which is to be detected relative to the laser and the photodetectors is possible in a simple and sufficiently accurate manner. With an increasing distance between sensor and object, the angle of the sensor relative to the surface of the object has to be complied with increasingly accurately in order to be able to detect a predefined region of the surface, with the result that the requirements made of the positioning increase.

Furthermore, the radiation intensity decreases with increasing distance from the radiation source, such that, with an increasing distance between sensor and object, the correspondingly reduced radiation intensity arriving at the object would have to be compensated for by a higher power of the radiation source. However, the sensor according to the invention is preferably equipped with a class 1 or 2 laser, in order to be able to operate the sensor without extensive protective measures. This holds true particularly because the sensor is “open” (that is to say that the laser beam emerges unimpeded from the sensor). This means that the power of the radiation source cannot be increased arbitrarily. In this respect, a short distance according to the invention of is advantageous.

Accordingly, the sensor according to the invention is characterized in that the intersection point of the central axes of the bushings lies outside the block at a distance of 2 to 10 mm from the outer surface and is simultaneously the focal point of the laser.

As a laser, in the sensor according to the invention it is possible to use in principle all sources for electromagnetic radiation which emit at least partly coherent radiation. With regard to a compact and cost-effective design of the sensor according to the invention, laser diodes are preferred. Laser diodes are generally known; they are semiconductor components in which a p-n junction with high doping is operated at high current densities. The choice of the semiconductor material determines the wavelength emitted. Laser diodes that emit visible radiation are preferably used. Lasers of class 1 or 2 are particularly preferably used. Classes are understood to mean the laser protection classes in accordance with the standard DIN EN 60825-1: lasers are classified in classes according to dangerousness to eyes and skin. Class 1 includes lasers whose irradiation values lie below the maximum permissible irradiation values even upon continuous irradiation. Class 1 lasers are not dangerous and, apart from the corresponding identification on the apparatus, require no further protective measures whatsoever. Class 2 includes lasers in the visible range for which an irradiation having a duration of less than 0.25 ms is not harmful to the eye (the duration of 0.25 ms corresponds to an eyelid closing reflex that can automatically protect the eye against longer irradiation). In a particularly preferred embodiment, class 2 laser diodes having a wavelength of between 600 nm and 780 nm are used.

The photodetectors used in the sensor according to the invention can be in principle all electronic components that convert electromagnetic radiation into an electrical signal. With regard to a compact and cost-effective design of the sensor according to the invention, photodiodes or phototransistors are preferred. Photodiodes are semiconductor diodes that convert electromagnetic radiation at a p-n junction or pin junction into an electric current by means of the internal photoelectric effect. A phototransistor is a bipolar transistor which has a pnp or npn layer sequence and whose pn junction of the base-collector depletion layer is accessible to electromagnetic radiation. It is similar to a photodiode with a connected amplifier transistor.

The sensor according to the invention has optical elements that produce a linear beam profile. A beam profile is understood to mean the two-dimensional intensity distribution of the laser beam in cross section at the focal point. The intensity is highest at the cross-sectional centre of the laser beam and decreases outwards. In this case, the gradient of the intensity in the case of a linear beam profile is lowest in a first direction, while it is highest in a second direction, running perpendicular to the first direction. The intensity distribution of the linear beam profile is preferably symmetrical, such that the cross-sectional profile of the laser at the focal point can be characterized by two mutually perpendicular axes, of which one runs parallel to the highest intensity gradient and the other runs parallel to the lowest intensity gradient.

The width of a laser beam cross-sectional profile—or else beam width for short—is understood hereinafter to mean that distance from the centre of the cross-sectional profile in the direction of the lowest intensity gradient at which the intensity has fallen to half its value at the centre.

Furthermore, the thickness of a laser beam cross-sectional profile—or else beam thickness for short—is understood to mean that distance from the centre of the cross-sectional profile in the direction of the highest intensity gradient at which the intensity has fallen to half its value at the centre.

The linear beam profile of the sensor according to the invention is characterized in that the beam width is greater than the beam thickness by a multiple. Preferably, the beam width is at least 50 times the beam thickness, particularly preferably at least 100 times, and especially preferably at least 150 times.

The beam width lies in the range of 2 mm to 7 mm, preferably in the range of 3 mm to 6.5 mm, particularly preferably in the range of 4 mm to 6 mm, and especially preferably in the range of 4.5 mm to 5.5 mm.

The beam thickness lies in the range of 5 μm to 35 μm, preferably in the range of 10 μm to 30 particularly preferably in the range of 15 μm to 30 μm, especially preferably in the range of 20 μm to 27 μm.

The person skilled in the art of optics knows how a linear beam profile according to the invention can be produced by means of optical elements.

The sensor according to the invention is characterized in that the beam width lies perpendicular to the plane in which the bushings are arranged. During the authentication, the sensor is moved over the object to be authenticated parallel to the plane in which the bushings are arranged.

As the size of the laser beam cross-sectional profile at the focal point decreases, the signal-to-noise ratio increases since the intensity is distributed over a smaller area. It has been found empirically that as the size of the laser beam cross-sectional profile at the focal point decreases, it becomes increasingly difficult to obtain reproducible signals. This is apparently owing to the fact that the surface of the object to be authenticated can no longer be positioned sufficiently accurately relative to the diminishing laser beam cross-sectional profile. It apparently becomes increasingly difficult to hit the region sufficiently accurately upon renewed authentication.

It has surprisingly been found that the abovementioned ranges for the beam thickness and the beam width are very well suited to obtaining the positioning that is sufficiently accurate for the reproducibility, on the one hand, and to obtaining a signal-to-noise ratio that is sufficient for a sufficiently accurate authentication, on the other hand.

The sensor according to the invention furthermore has means for connecting a plurality of sensors or for connecting a sensor to a mount. These means can be fitted to the block or to a housing into which the block can be introduced.

These means permit two or more sensors to be connected to one another in a predetermined manner. Preferably, the block or the housing has positive connecting means on one side and negative connecting means on the opposite side, such that a sensor can be connected on both sides of the block/housing to a mount and/or a further sensor in a defined manner, wherein the further sensors can in turn be connected, on the sides still free, to in turn further sensors. This modular principle permits the combination of a multiplicity of sensors in a predefined manner. Positive connecting means that are taken into consideration include projections, for example, which can be inserted into cutouts as negative connecting means. Further connecting means known to the person skilled in the art, such as insertion rails or the like, are conceivable. A plurality of sensors are preferably connected to one another in such a way that the beam widths of all the sensors are arranged along a line.

The connection of two or more sensors is effected in a reversible manner, that is to say that it is releasable. The connecting means can also be used to fit the sensor according to the invention to a mount.

The connection of a plurality of sensors affords the following advantages:
As a result of the connection of a plurality of sensors it is possible, with the duration for authentication remaining the same, to record more data and thus to increase the security during authentication.
Instead of one surface region of an object to be authenticated in a time interval, in the case of connected sensors a plurality of regions are irradiated in the same time interval with a respective laser beam and reflected light is detected. Accordingly, larger amounts of data which characterize the object are recorded. This increases the accuracy with which one object from a large number of similar objects can be reliably identified and authenticated. WO2005088533(A1) discloses that the security during authentication can be increased by means of a larger number of photodetectors in the plane of the laser. WO2005088533(A1) does not disclose, however, how additional photodetectors can be arranged in said plane in a simple manner. Moreover, not all angles at which the photodetectors are arranged with respect to the laser are equivalent, as has already been ascertained in WO2005088533(A1). In the case of paper-like objects that are irradiated perpendicularly with laser radiation, the intensity of the reflected radiation is highest around the angle of incidence. With an increasing angle of the reflected radiation with respect to the angle of incidence, the intensity of the reflected radiation decreases. In the case of a fan-shaped, planar arrangement of laser and photodetectors, therefore, not all of the photodetectors receive radiation with the same intensity. Consequently, although additional photodetectors in the plane around the laser increase the security during authentication, each further photodetector does not increase the security to the same extent since additional photodetectors have to be arranged in regions in which the reflected radiation has a lower intensity.
The releasable combination according to the invention of a plurality of sensors affords the user the possibility of reacting flexibly to the respective application. If a higher security is required during authentication, then two or more sensors can be connected to one another and, in a simple manner, larger amounts of data can be detected in a time interval that remains the same. By contrast, if e.g. only a simple check of authentication is called for, an individual sensor can be used.
As a result of the connection of a plurality of sensors it is possible to detect and/or authenticate a plurality of objects simultaneously. By way of example, it is possible to install a multiplicity of sensors in a production installation. Products are transported at a high speed e.g. by means of a conveyor belt. In order to be able to authenticate these products at a later point in time, characteristic features have to be detected and stored e.g. in a database. For this purpose, it is advantageous to connect a plurality of sensors in order to increase the throughput during detection. It is conceivable to connect the sensors to one another by means of spacers if the products are so far apart that they can no longer be individually detected by sensors that are directly connected to one another. The connecting means make it possible to connect the sensors to one another in such a way that they assume a defined position with respect to one another. As a result, the reproducibility during data acquisition is increased and the individual products can be reliably authenticated at a later point in time.

The present invention likewise relates to a device comprising two or more sensors that are reversibly connected to one another directly or by means of a spacer.

In one preferred embodiment of the sensor according to the invention, the sensor has a housing, into which the block is introduced. Further components, e.g. the control electronics for the laser, signal preprocessing electronics, complete evaluation electronics and the like, can be introduced into the housing of the sensor. The housing preferably also serves for anchoring a connecting cable by which the sensor according to the invention can be connected to a control unit and/or a data acquisition unit for controlling the sensor and/or for detection and further processing of the characteristic reflection patterns.

The sensor optionally also has a window which is fitted in front of, behind or in the outer surface and protects the optical components against damage and contamination. The window preferably forms the outer surface of the sensor. The window is at least partly transparent to the wavelength of the laser used.

The sensor according to the invention is suitable in combination with a control and data acquisition unit for identifying and/or authenticating objects. The sensor according to the invention is preferably led over an object at a constant distance. The laser irradiates the object, wherein the laser beam is incident perpendicularly or virtually perpendicularly on the object. The laser beam has a linear beam profile. The sensor is preferably led over the object in such a way that the beam width is perpendicular to the direction of movement. Of course, it is also conceivable to lead the object past the sensor instead of moving the sensor. The laser radiation is reflected from the object. Part of the reflected radiation is detected by means of photodetectors and converted into electrical signals. The sensor according to the invention is suitable in particular for identifying and/or authenticating paper-like objects which, upon irradiation with laser light, produce a characteristic reflection pattern that can be detected by means of the photodetectors. Paper-like objects are understood to mean objects which are produced from a fibrous material, such as e.g. paper, cardboard, textiles, felt, and the like.

The sensor according to the invention permits connection to one or a plurality of further sensors, with the result that the volume of data during the optical detection of characteristic features of an object can be increased with the authentication duration remaining the same and the security during authentication can thus be increased. The connection of a plurality of sensors, if appropriate by means of a spacer, likewise enables the simultaneous detection of characteristic reflection patterns from a plurality of objects in a reproducible manner.

The sensor according to the invention can be produced cost-effectively on an industrial scale in series production, has a compact design, is intuitive and simple to handle, flexibly usable and extendable and yields reproducible and transferable results. The task of aligning the optical components with respect to one another is achieved in a simple manner by means of the design, which unambiguously defines the position of the components with respect to one another.

The invention is explained in more detail below on the basis of a concrete exemplary embodiment, but without restricting the invention thereto.

In the figures:

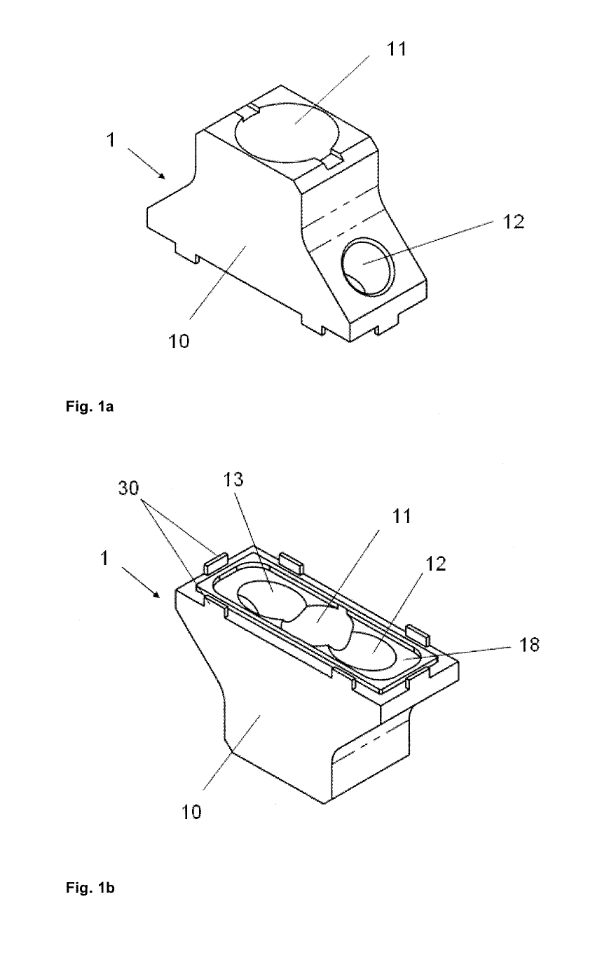

FIG. 1a, 1b show a sensor without optical components in a perspective illustration

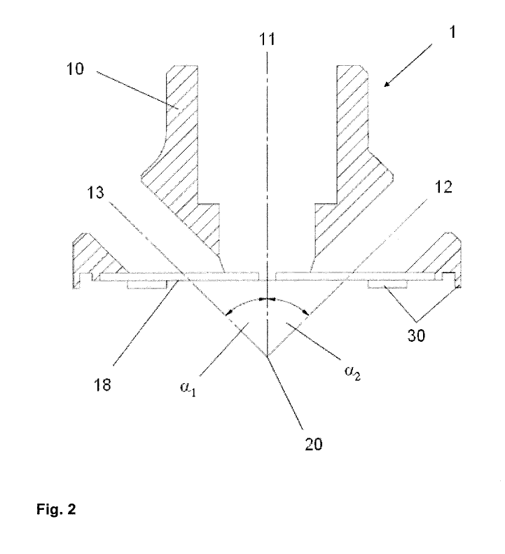

FIG. 2 shows a block of the sensor according to the invention in cross section

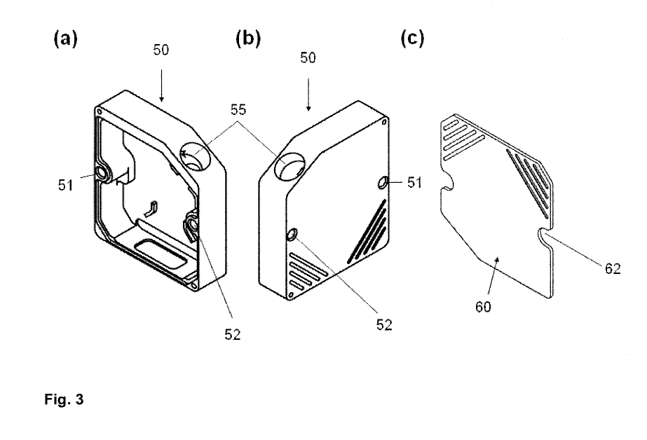

FIG. 3 shows a housing with cover

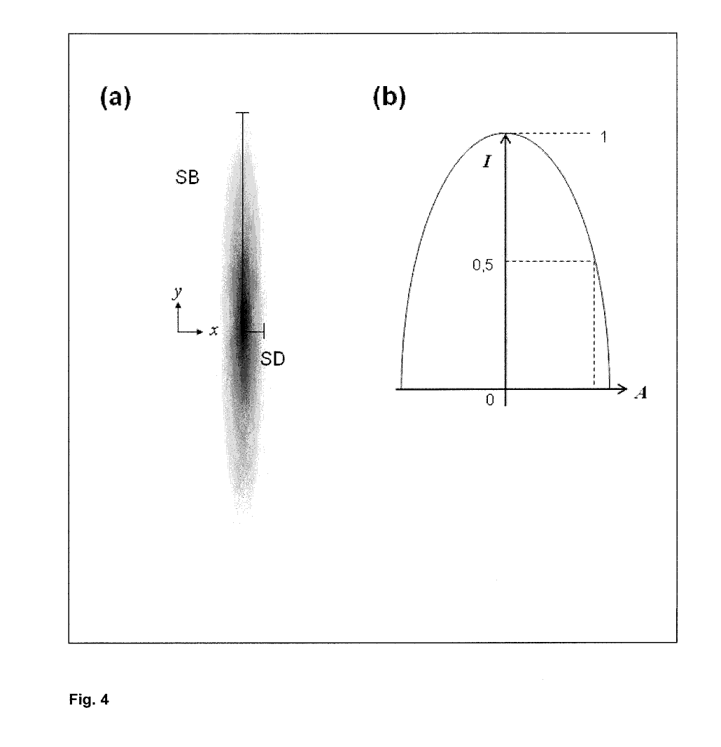

FIG. 4 shows a schematic illustration of a linear beam profile

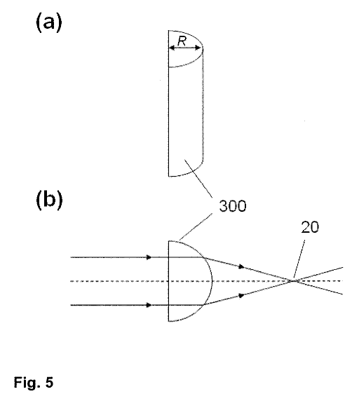

FIG. 5 shows a planoconvex cylindrical lens for producing a linear beam profile

### REFERENCE SYMBOLS

1 Sensor
10 Block
11 Bushing
12 Bushing
13 Bushing
18 Outer surface
20 Focal point
30 Holding element
50 Housing
51 Bushing, connecting means
52 Bushing, connecting means
55 Cable bushing
60 Cover
62 Cutout
300 planoconvex cylindrical lens

FIGS. 1a and 1b show a sensor 1 according to the invention without optical components (laser, photodetectors, lenses) in a perspective illustration. The sensor according to the invention comprises a block 10, into which three bushings 11, 12, 13 are introduced. The bushing 11 serves to receive a laser. The bushings 12 and 13 serve to receive two photodetectors. The bushing 11 runs perpendicularly with respect to an outer surface 18 of the sensor. During operation of the sensor, the outer surface 18 is directed at the object which is intended to be authenticated. The block 10 comprises holding means 30 for receiving and fixing a window. The window (not illustrated in the figure) is at least partly transmissive to the wavelength of the laser used. Partial transmissivity is understood to mean a transmissivity of at least 50%, that is to say that 50% of the radiation intensity radiated in penetrates through the window.

FIG. 2 shows the sensor 1 from FIGS. 1 and 2 in cross section. It reveals the bushing 11 for receiving the laser and the bushings 12 and 13—running at an angle of α₁ and α₂, respectively, with respect to said bushing 11—for receiving two photodetectors. In the present example, the angles α₁ and α₂ are identical and are 45°.

The bushings 11, 12, 13 are arranged in the block 10 in such a way that their central axes intersect at a point 20 lying at a distance of 2 mm to 10 mm from the outer surface 18. Said point 20 is simultaneously the focal point of the laser.

Subfigures 3(a) and 3(b) show a housing 50 in perspective illustration, into which the sensor from FIGS. 1a, 1b and 2 can be introduced. Subfigure 3(c) shows a cover 60 associated with the housing. The housing has bushings 51, 52. The bushings can be used as connecting means in order to releasably connect a plurality of sensors to one another or in order to fix the sensor to a mount. The cover 60 has corresponding cutouts 62. Via a cable bushing 55, the sensor is connected to control electronics and/or a computer unit for recording the reflection data.

Subfigures 4(a) and 4(b) illustrate a linear beam profile having a beam width SB and a beam thickness SD. Subfigure 4(a) illustrates the two-dimensional cross-sectional profile of a laser beam at the focal point. The highest intensity is present at the centre of the cross-sectional profile. The intensity I decreases outwards, wherein there is a first direction (x), in which the intensity I decreases to the greatest extent with increasing distance A from the centre, and a further direction (y), which is perpendicular to the first direction (x), in which the intensity I decreases to the weakest extent with increasing distance A from the centre. Subfigure 4(b) shows the intensity profile I as a function of the distance A from the centre. The beam width and the beam thickness are defined as the distances from the centre at which the intensity I has fallen to 50% of its maximum value at the centre, wherein here the beam width lies in the y-direction and the beam thickness lies in the x-direction.

FIG. 5 shows by way of example how a linear beam profile can be produced with the aid of a planoconvex cylindrical lens 300. The cylindrical lens 300 acts as a converging lens (FIG. 5(b)) in one plane. In the plane perpendicular thereto, said lens has no refractive effect. In the paraxial approximation, the following formula holds true for the focal length f of such a lens:

$$f = \frac{R}{n - 1} \qquad Equ . 1$$

where R is the cylinder radius and n is the refractive index of the material.

1. A sensor for recording reflection patterns comprising
a block having an outer surface and a first bushing, which runs perpendicularly towards the outer surface of the block, and at least a second bushing, which runs at an angle α (alpha) with respect to the first bushing and runs towards the first bushing in the direction of the outer surface,
a laser, which is arranged in the first bushing and which emits a laser beam in the direction of the outer surface,
optical elements for shaping a linear beam profile,
at least one photodetector arranged in the at least second bushing and directed in the direction of the outer surface,
connecting means for connecting the sensor to further sensors or to a mount, and
wherein the central axes of the bushings intersect at a point which lies at a distance of 2 to 10 mm from the outer surface and is simultaneously the focal point of the laser.

2. The sensor according to claim 1, wherein the beam width of the linear beam profile is at least 50 times the beam thickness.

3. The sensor according to claim 1, wherein the beam width lies in the range of 3 mm to 6.5 mm, and the beam thickness lies in the range of 10 μm to 30 μm.

4. The sensor according to claim 1, wherein the angle α (alpha) lies in the range of 20° to 80°.

5. The sensor according to claim 1, furthermore comprising a window which is fitted in, in front of or behind the outer surface and protects the optical components of the sensor against damage and/or contamination.

6. A device comprising two or more sensors each sensor comprising
a block having an outer surface and a first bushing, which runs perpendicularly towards the outer surface of the block, and at least a second bushing, which runs at an angle α (alpha) with respect to the first bushing and runs towards the first bushing in the direction of the outer surface,
a laser, which is arranged in the first bushing and which emits a laser beam in the direction of the outer surface,
optical elements for shaping a linear beam profile,
at least one photodetector arranged in the at least second bushing and directed in the direction of the outer surface,
connecting means for connecting the sensor to further sensors or to a mount, and
wherein the central axes of the bushings intersect at a point which lies at a distance of 2 to 10 mm from the outer surface and is simultaneously the focal point of the laser, and
which two or more sensors are releasably connected to one another.

7. The device according to claim 6, wherein the sensors are connected to one another by means of spacers.

8. The sensor according to claim 1, wherein the beam width of the linear beam profile is at least 100 times the beam thickness.

9. The sensor according to claim 1, wherein the beam width of the linear beam profile is at least 150 times the beam thickness.

10. The sensor according to claim 1, wherein the beam width lies in the range of 3 mm to 6.5 mm, and the beam thickness lies in the range of 10 μm to 30 μm.

11. The sensor according to claim 1, wherein the beam width lies in the range of 4 mm to 6 mm, and the beam thickness lies in the range of 15 μm to 30 μm.

12. The sensor according to claim 1, wherein the beam width lies in the range of 4.5 mm to 5.5 mm, and the beam thickness lies in the range of 20 μm to 27 μm.

13. The sensor according to claim 1, wherein the angle α (alpha) lies in the range of 30° to 70°.

14. The sensor according to claim 1, wherein the angle α (alpha) lies in the range of 40° to 60°.
